(19) United States
(12) Patent Application Publication
(10) Pub. No.: US 2025/0348236 A1
(43) Pub. Date: Nov. 13, 2025

(54) ELECTRONIC DEVICE COMMUNICATING WITH EXTERNAL DEVICE, OPERATING METHOD OF ELECTRONIC DEVICE, AND ELECTRONIC SYSTEM INCLUDING ELECTRONIC DEVICES

(71) Applicant: SAMSUNG ELECTRONICS CO., LTD., Suwon-si (KR)

(72) Inventors: Tae Hyoung Kim, Seongnam-si (KR); Donghyun Yoon, Hwaseong-si (KR); Ikjin Jo, Suwon-si (KR); Myoungbo Kwak, Suwon-si (KR); Jueon Kim, Suwon-si (KR); Jaewoo Park, Suwon-si (KR); Junghwan Choi, Suwon-si (KR)

(73) Assignee: NANYANG TECHNOLOGICAL UNIVERSITY, Singapore (SG)

(21) Appl. No.: 18/932,035

(22) Filed: Oct. 30, 2024

(30) Foreign Application Priority Data
May 7, 2024 (KR) 10-2024-0059935

(51) Int. Cl. G06F 3/06; G06F 13/40

(52) U.S. Cl. CPC G06F 3/0625; G06F 3/0659; G06F 3/0673; G06F 13/4086

(57) ABSTRACT

An electronic device includes a pad that is connected to an external device, and a transmitter that drives the pad to one of a first state, a second state, and a third state when a signal is transmitted to the external device. The first state includes a pull-up state, the second state includes a pull-down state, and the third state includes a state in which the pad is connected to a ground node to which a ground voltage is applied through a matching circuit.

### CROSS-REFERENCE TO RELATED APPLICATIONS

This application claims priority to Korean Patent Application No. 10-2024-0059935 filed in the Korean Intellectual Property Office on May 7, 2024, the disclosure of which is incorporated by reference herein in its entirety.

### BACKGROUND

An electronic device may communicate with an external electronic device. For example, a memory device may communicate with a memory controller. To increase a communication speed of electronic devices, the frequency of signals which are communicated between the electronic devices is increasing. When the frequency of the communicated signals increases, the amount of power which the electronic devices consume for communication may increase.

A mobile device such as a smartphone, a smart pad, or a smart watch operates based on a battery. Accordingly, electronic devices installed in the mobile device, for example, memory devices installed in the mobile device need to be implemented to operate with a low power. In particular, because the frequency of signals communicated between memory devices is expected as continuing to increase, accordingly, there is a need to reduce power consumption when electronic devices such as memory devices communicate with each other.

### SUMMARY

In general, in some aspects, the present disclosure is directed toward an electronic device that performs communication with a reduced power, an operating method of the electronic device, and an electronic system including electronic devices.

According to some implementations, the present disclosure is directed to an electronic device that includes a pad that is connected to an external device, and a transmitter that drives the pad to one of a first state, a second state, and a third state when a signal is transmitted to the external device. The first state includes a pull-up state, the second state includes a pull-down state, and the third state includes a state in which the pad is connected to a ground node to which a ground voltage is applied through a matching circuit.

According to some implementations, the present disclosure is directed to an operating method of an electronic device that includes a transmitter and a receiver configured to communicate with an external device includes turning on a pull-up circuit of the transmitter, turning off a pull-down circuit of the transmitter, and deactivating a matching circuit of the transmitter, when transmitting a first signal to the external device, turning off the pull-up circuit, turning on the pull-down circuit, and deactivating the matching circuit, when transmitting a second signal to the external device, and turning off the pull-down circuit, and activating the matching circuit, when transmitting a third signal to the external device, turning off the pull-up circuit.

According to some implementations, the present disclosure is directed to an electronic system that includes a first electronic device that includes a first transmitter and a first receiver, and a second electronic device that includes a second transmitter and a second receiver. When the first transmitter is pulled up, the second receiver generates a first signal in response to the pull-up. When the first transmitter is pulled down, the second receiver generates a second signal in response to the pull-down. When the first transmitter activates a first matching circuit, the second receiver generates a third signal.

### BRIEF DESCRIPTION OF THE DRAWINGS

Example implementations will be more clearly understood from the following detailed description, taken in conjunction with the accompanying drawings.

FIG. 1 illustrates an example of an electronic system according to some.

FIG. 2 illustrates an example of a transceiver according to some implementations.

FIG. 3 illustrates an example of a transmission matching circuit according to some implementations.

FIG. 4 illustrates an example of a reception buffer according to some implementations.

FIG. 5 illustrates an example in which a transmitter of a transceiver of a first electronic device and a receiver of a transceiver of a second electronic device are connected according to some implementations.

FIG. 6 illustrates an example of a method in which a first electronic device and a second electronic device communicate with each other according to some implementations.

FIGS. 7, 8, and 9 illustrate examples of processes in which communication is performed depending on the method of FIG. 6 according to some implementations.

FIG. 10 illustrates an example of a pull-up circuit according to some implementations.

FIG. 11 illustrates an example of a pull-down circuit according to some implementations.

FIG. 12 illustrates an example of a transmission matching circuit according to some implementations.

FIG. 13 illustrates an example of a reception resistor according to some implementations.

FIG. 14 illustrates an example of an electronic system according to some implementations.

FIG. 15 illustrates an example of an electronic system according to some implementations.

FIG. 16 illustrates an example of an electronic system according to some implementations.

### DETAILED DESCRIPTION

Hereinafter, example implementations will be explained in detail with reference to the accompanying drawings.

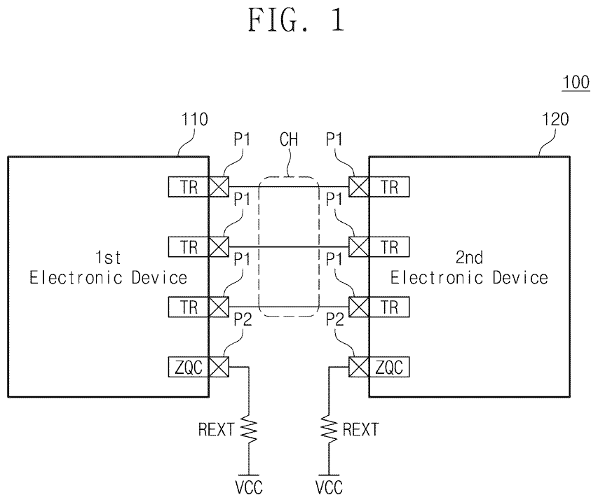

FIG. 1 illustrates an example of an electronic system according to some implementations. In FIG. 1, an electronic system 100 may include a first electronic device 110 and a second electronic device 120. Each of the first electronic device 110 and the second electronic device 120 may include first pads P1 and a second pad P2. Each of the first electronic device 110 and the second electronic device 120 may include transceivers TR connected to the first pads P1. Each of the first electronic device 110 and the second electronic device 120 may further include a ZQ calibration controller ZQC connected to the second pad P2 and configured to perform ZQ calibration.

A channel CH may be provided between the first electronic device 110 and the second electronic device 120. For example, the channel CH may include signal lines connecting the first pads P1 of the first electronic device 110 and the first pads P1 of the second electronic device 120, respectively.

Each of the first electronic device 110 and the second electronic device 120 may transmit signals to the counterpart electronic device through the first pads P1 and the channel CH by controlling the transceivers TR. Each of the first electronic device 110 and the second electronic device 120 may receive signals input to the first pads P1 from the counterpart electronic device through the channel CH, by using the transceivers TR.

Each of the first electronic device 110 and the second electronic device 120 may perform ZQ calibration by using the ZQ calibration controller ZQC and an external resistor REXT connected to the second pad P2. Each of the first electronic device 110 and the second electronic device 120 may perform ZQ calibration to adjust an intensity by which each transceiver TR drives a signal.

In some implementations, each of the first electronic device 110 and the second electronic device 120 is connected to the external resistor REXT. In some implementations, the first electronic device 110 and the second electronic device 120 may be connected in common to one external resistor. In some implementations, the external resistor REXT of each of the first electronic device 110 and the second electronic device 120 is connected to a power node to which a first power supply voltage VCC is supplied, but the external resistor REXT of each of the first electronic device 110 and the second electronic device 120 may be connected to a ground node to which a ground voltage is supplied.

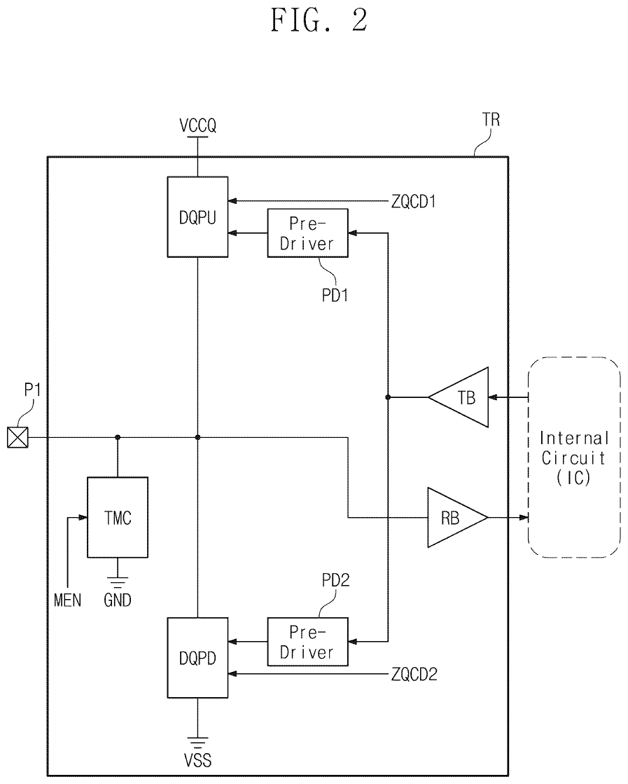

FIG. 2 illustrates an example of the transceiver TR according to some implementations. In some implementations, the transceiver TR may correspond to one of the transceivers TR of the first electronic device 110 or the second electronic device 120 of FIG. 1.

In FIGS. 1 and 2, the transceiver TR may be connected between the first pad P1 and an internal circuit IC. The internal circuit IC may include various components and may be configured to perform intended functions of the first electronic device 110 or the second electronic device 120 and to communicate with an external device by using the transceiver TR.

The transceiver TR may include a transmission buffer TB, a first pre-driver PD1, a second pre-driver PD2, a pull-up circuit DQPU, a pull-down circuit DQPD, a transmission matching circuit TMC, and a reception buffer RB. The first pre-driver PD1, the second pre-driver PD2, the pull-up circuit DQPU, the pull-down circuit DQPD, and the transmission matching circuit TMC may be implemented as a transmitter of the transceiver TR. The reception buffer RB may be implemented as a receiver of the transceiver TR.

The transmission buffer TB may receive a signal corresponding to data for communicating with an external device from the internal circuit IC. For example, a signal which the first electronic device 110 or the second electronic device 120 communicates through the first pads P1 may be based on the pulse amplitude modulation 3 (PAM3). The PAM3 signal may have one of three values at a time. For example, the PAM3 signal may have a value corresponding to one of “-”. “0”, and “1”. In some implementations, “-”, “0”, and “1” may respectively correspond to a low level, a middle level, and a high level. The transmission buffer TB may receive a signal indicating one of the low level, the middle level, and the high level from the internal circuit IC.

The first pre-driver PD1 may control the pull-up circuit DQPU based on the signal received from the transmission buffer TB. For example, the first pre-driver PD1 may turn on or turn off the pull-up circuit DQPU. The second pre-driver PD2 may control the pull-down circuit DQPD based on the signal received from the transmission buffer TB. For example, the second pre-driver PD2 may turn on or turn off the pull-down circuit DQPD.

The pull-up circuit DQPU may be turned on or turned off by the first pre-driver PD1. When the pull-up circuit DQPU is turned off by the first pre-driver PD1, the pull-up circuit DQPU may electrically separate the first pad P1 from a power node to which a second power supply voltage VCCQ is applied. When the pull-up circuit DQPU is turned on by the first pre-driver PD1, the pull-up circuit DQPU may connect the first pad P1 and the power node to which the second power supply voltage VCCQ is applied and thus may pull up the first pad P1.

In some implementations, the pull-up circuit DQPU may include a first variable resistance element whose resistance value is varied by a first ZQ calibration code ZQCD1. When the pull-up circuit DQPU is turned on by the first pre-driver PD1, the pull-up circuit DQPU may electrically connect the first pad P1 to the power node through the first variable resistance element. The first ZQ calibration code ZQCD1 may be obtained as a result of the ZQ calibration which the first electronic device 110 or the second electronic device 120 performs.

The pull-down circuit DQPD may be turned on or turned off by the second pre-driver PD2. When the pull-down circuit DQPD is turned off by the second pre-driver PD2, the pull-down circuit DQPD may electrically separate the first pad P1 from a ground node to which a ground voltage GND is applied. When the pull-down circuit DQPD is turned on by the second pre-driver PD2, the pull-down circuit DQPD may connect the first pad P1 to the ground node to which the ground voltage GND is applied and thus may pull down the first pad P1.

In some implementations, the pull-down circuit DQPD may include a second variable resistance element whose resistance value is varied by a second ZQ calibration code ZQCD2. When the pull-down circuit DQPD is turned on by the second pre-driver PD2, the pull-down circuit DQPD may electrically connect the first pad P1 to the ground node through the second variable resistance element. The second ZQ calibration code ZQCD2 may be obtained as a result of the ZQ calibration which the first electronic device 110 or the second electronic device 120 performs.

The transmission matching circuit TMC may be activated or deactivated in response to a matching enable signal MEN received from the internal circuit IC. When the transmission matching circuit TMC is activated in response to the matching enable signal MEN, impedance components of the transmission matching circuit TMC may be electrically connected to the first pad P1 and may be applied to the first pad P1. When the transmission matching circuit TMC is deactivated in response to the matching enable signal MEN, the impedance components of the transmission matching circuit TMC may be electrically separated from the first pad P1 and thus may not be applied to the first pad P1.

In some implementations, the transmission matching circuit TMC may be selectively activated while the transmitter of the transceiver TR transmits a signal through the first pad P1. The transmission matching circuit TMC may be deactivated during a time interval where the transmitter of the transceiver TR does not transmit a signal through the first pad P1 (e.g., the time interval including a time during the receiver of the transceiver TR receives a signal).

The reception buffer RB may buffer a PAM3-based signal received through the first pad P1 so as to be transferred to the internal circuit IC.

When the internal circuit IC intends to transmit a signal to an external electronic device, the internal circuit IC may provide a PAM3-based signal to the transmission buffer TB. When the transmission buffer TB receives a signal of the high level from the internal circuit IC, the transmission buffer TB may control the first pre-driver PD1 and the second pre-driver PD2 such that the transmitter of the transceiver TR is pulled up. For example, when the first pre-driver PD1 turns on the pull-up circuit DQPU and the second pre-driver PD2 turns off the second pre-driver PD2, the transmitter of the transceiver TR may output the high level through the first pad P1.

When the transmission buffer TB receives a signal of the low level from the internal circuit IC, the transmission buffer TB may control the first pre-driver PD1 and the second pre-driver PD2 such that the transmitter of the transceiver TR is pulled down. For example, when the first pre-driver PD1 turns off the pull-up circuit DQPU and the second pre-driver PD2 turns on the second pre-driver PD2, the transmitter of the transceiver TR may output the low level through the first pad P1.

When the transmission buffer TB receives a signal of the middle level from the internal circuit IC, the transmission buffer TB may control the first pre-driver PD1 and the second pre-driver PD2 such that the transmitter of the transceiver TR is turned off. For example, the first pre-driver PD1 may turn off the pull-up circuit DQPU, and the second pre-driver PD2 may turn off the second pre-driver PD2.

Also, when the internal circuit IC intends to transmit the signal of the middle level, the internal circuit IC may control the matching enable signal MEN such that the transmitter of the transceiver TR is impedance matched. For example, the internal circuit IC may activate the matching enable signal MEN to activate the transmission matching circuit TMC. That is, the impedance of the transmission matching circuit TMC may be applied to the first pad P1.

In some implementations, the middle level may be generated at the receiver of the transceiver TR of the external device connected to the first pad P1, by the receiver of the transceiver TR of the external device. That is, the internal circuit IC may transmit the signal of the middle level without power consumption of the transmitter of the transceiver TR by turning off the pull-up circuit DQPU and the pull-down circuit DQPD. Accordingly, the power consumption of the transceiver TR, the first electronic device 110 and the second electronic device 120, each of which includes the transceiver TR, and the electronic system 100 may be reduced.

In some implementations, the internal circuit IC may deactivate the matching enable signal MEN in the remaining cases other than the case where the internal circuit IC intends to transmit the signal of the middle level and may deactivate the transmission matching circuit TMC. Accordingly, except for the case where the signal of the middle level is transmitted, the transmission matching circuit TMC may not affect operations of the transceiver TR, the first electronic device 110 and the second electronic device 120, each of which includes the transceiver TR, and the electronic system 100.

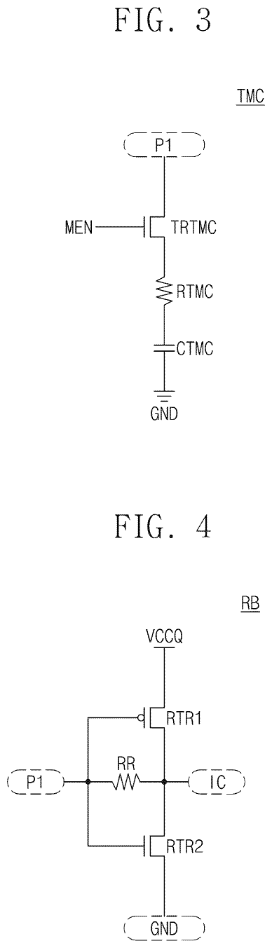

FIG. 3 illustrates an example of a transmission matching circuit TMC according to some implementations. In FIGS. 2 and 3, the transmission matching circuit TMC may include a transmission matching transistor TRTMC, a transmission matching resistor RTMC, and a transmission matching capacitor CTMC.

The transmission matching transistor TRTMC may include a gate through which the matching enable signal MEN is received, a first terminal connected to the first pad P1, and a second terminal connected to the transmission matching resistor RTMC. The transmission matching resistor RTMC and the transmission matching capacitor CTMC may be connected between the transmission matching transistor TRTMC and the ground node to which the ground voltage GND is supplied.

When the matching enable signal MEN is activated, the matching enable signal MEN may have the high level. The transmission matching transistor TRTMC may be turned on in response to the matching enable signal MEN with the high level. The turned-on transmission matching transistor TRTMC may electrically connect the transmission matching resistor RTMC and the transmission matching capacitor CTMC to the first pad P1. Accordingly, the impedance of the transmission matching circuit TMC including the transmission matching resistor RTMC and the transmission matching capacitor CTMC may be applied to the first pad P1. That is, the transmission matching circuit TMC may be activated.

When the matching enable signal MEN is deactivated, the matching enable signal MEN may have the low level. The transmission matching transistor TRTMC may be turned off in response to the matching enable signal MEN with the low level. The turned-off transmission matching transistor TRTMC may electrically disconnect the transmission matching resistor RTMC and the transmission matching capacitor CTMC from the first pad P1. Accordingly, the impedance of the transmission matching circuit TMC including the transmission matching resistor RTMC and the transmission matching capacitor CTMC may not be applied to the first pad P1. That is, the transmission matching circuit TMC may be deactivated.

FIG. 4 illustrates an example of a reception buffer RB according to some implementations. In FIGS. 2 and 4, the reception buffer RB may include a first reception transistor RTR1, a second reception transistor RTR2, and a reception resistor RR.

The first reception transistor RTR1 may include a gate connected to the corresponding first pad P1, a first terminal connected to the power node to which the second power supply voltage VCCQ is applied, and a second terminal connected to a node of the internal circuit IC. In an embodiment, the first reception transistor RTR1 may be implemented with a PMOS transistor.

The second reception transistor RTR2 may include a gate connected to the corresponding first pad P1, a first terminal connected to the node of the internal circuit IC, and a second terminal connected to the ground node to which the ground voltage GND is applied. In some implementations, the second reception transistor RTR2 may be implemented with an NMOS transistor.

The reception resistor RR may be connected between the corresponding first pad P1 and the node of the internal circuit IC. In some implementations, the reception buffer RB may be implemented with a transimpedance amplifier (TIA) receiver (e.g., an inverter-based TIA receiver).

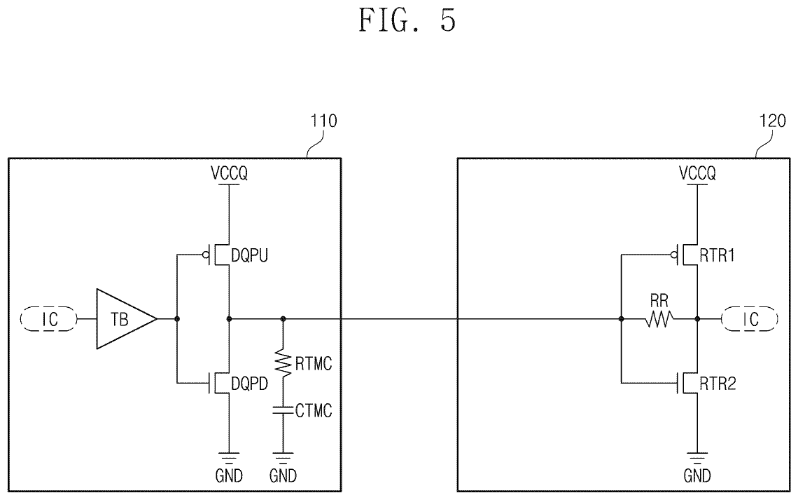

FIG. 5 illustrates an example in which the transmitter of the transceiver TR of the first electronic device 110 and the receiver of the transceiver TR of the second electronic device 120 are connected according to some implementations. In FIGS. 1, 2, 3, 4, and 5, the pull-up circuit DQPU of the transmitter of the first electronic device 110 may be simply modeled by a transistor (e.g., a PMOS transistor), and the pull-down circuit DQPD thereof may be simply modeled by a transistor (e.g., an NMOS transistor).

The transmission matching circuit TMC may be simply modeled by the transmission matching resistor RTMC and the transmission matching capacitor CTMC. The receiver of the transceiver TR of the second electronic device 120 is illustrated as described with reference to FIG. 4.

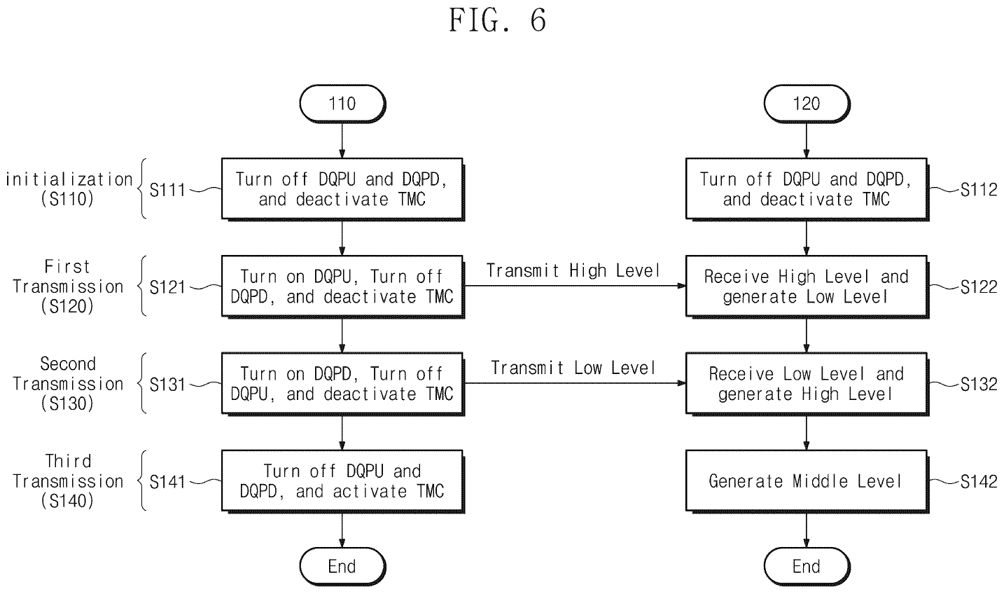

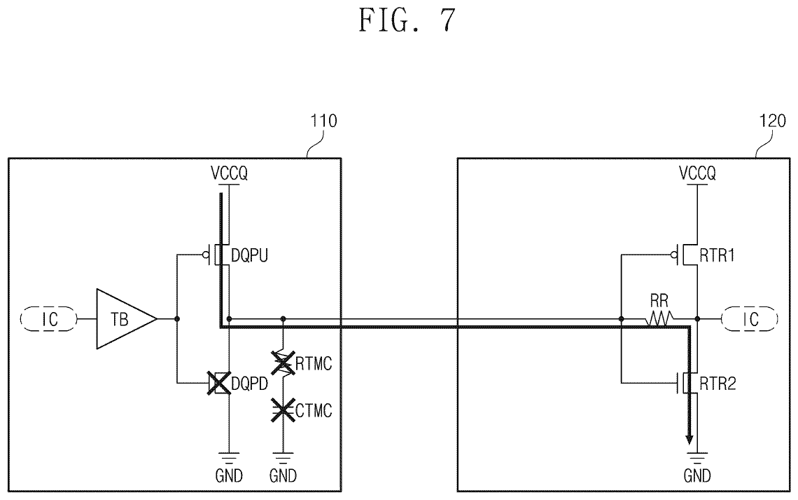

FIG. 6 illustrates an example of a method in which the first electronic device 110 and the second electronic device 120 communicate with each other according to some implementations. In some implementations, an example of a method in which the first electronic device 110 transmits a signal to the second electronic device 120 is illustrated in FIG. 6. FIGS. 7, 8, and 9 illustrate processes in which communication is performed depending on the method of FIG. 6.

In FIGS. 1, 2, and 6, in operation S110, the first electronic device 110 and the second electronic device 120 may perform initialization. For example, the first electronic device 110 and the second electronic device 120 may perform initialization for communication.

Operation S110 may include operation S111 and operation S112. In operation S111, the first electronic device 110 may turn off the pull-up circuit DQPU and may turn off the pull-down circuit DQPD. Also, the first electronic device 110 may deactivate the transmission matching circuit TMC. In operation S112, the second electronic device 120 may turn off the pull-up circuit DQPU and may turn off the pull-down circuit DQPD. Also, the second electronic device 120 may deactivate the transmission matching circuit TMC.

In operation S120, the first electronic device 110 and the second electronic device 120 may perform first transmission. For example, the first electronic device 110 may transmit the high level to the second electronic device 120.

Operation S120 may include operation S121 and operation S122. Referring to FIGS. 6 and 7, in operation S121, the first electronic device 110 may turn on the pull-up circuit DQPU and may turn off the pull-down circuit DQPD. Also, the first electronic device 110 may deactivate the transmission matching circuit TMC.

In operation S122, the second electronic device 120 may receive the high level and may generate the low level. The high level transmitted from the first electronic device 110 may turn off the first reception transistor RTR1 of the second electronic device 120 and may turn on the second reception transistor RTR2 thereof. As the second reception transistor RTR2 is turned on, the second electronic device 120 may generate the low level corresponding to the ground voltage GND. The internal circuit IC of the second electronic device 120 may receive the low level.

In FIGS. 1, 2, and 6, in operation S130, the first electronic device 110 and the second electronic device 120 may perform second transmission. For example, the first electronic device 110 may transmit the low level to the second electronic device 120.

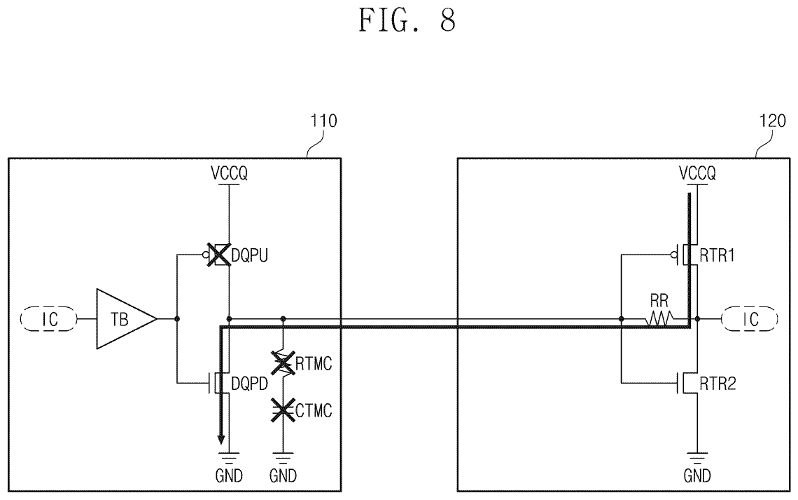

Operation S130 may include operation S131 and operation S132. Referring to FIGS. 6 and 8, in operation S131, the first electronic device 110 may turn off the pull-up circuit DQPU and may turn on the pull-down circuit DQPD. Also, the first electronic device 110 may deactivate the transmission matching circuit TMC.

In operation S132, the second electronic device 120 may receive the low level and may generate the high level. The low level transmitted from the first electronic device 110 may turn on the first reception transistor RTR1 of the second electronic device 120 and may turn off the second reception transistor RTR2 thereof. As the first reception transistor RTR1 is turned on, the second electronic device 120 may generate the high level corresponding to the second power supply voltage VCCQ. The internal circuit IC of the second electronic device 120 may receive the high level.

In FIGS. 1, 2, and 6, in operation S140, the first electronic device 110 and the second electronic device 120 may perform third transmission. For example, the first electronic device 110 and the second electronic device 120 may allow the middle level to be generated in the second electronic device 120.

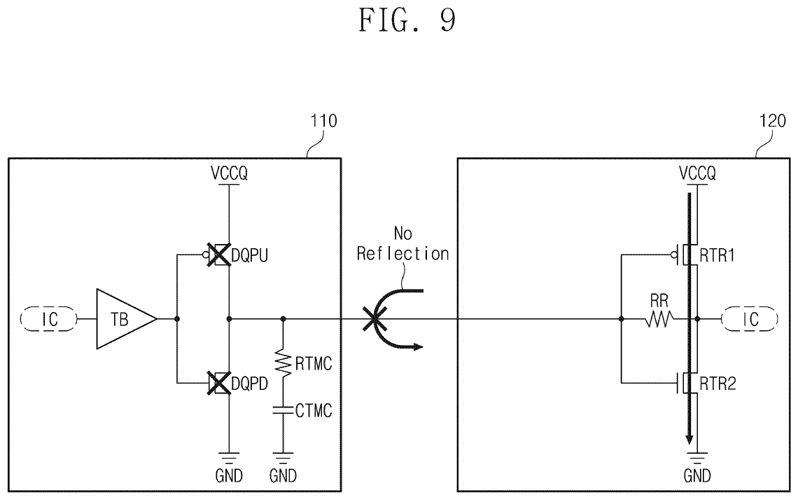

Operation S140 may include operation S141 and operation S142. Referring to FIGS. 6 and 9, in operation S141, the first electronic device 110 may turn off the pull-up circuit DQPU and may turn off the pull-down circuit DQPD. Also, the first electronic device 110 may activate the transmission matching circuit TMC.

In operation S142, the first reception transistor RTR1 and the second reception transistor RTR2 of the second electronic device 120 may be turned on by the connection of the reception resistor RR. As the first reception transistor RTR1 and the second reception transistor RTR2 are turned on, a current may flow to the ground node to which the ground voltage GND is applied, from the power node to which the second power supply voltage VCCQ is applied, through the first reception transistor RTR1 and the second reception transistor RTR2.

The first reception transistor RTR1 and the second reception transistor RTR2 may divide the second power supply voltage VCCQ and the ground voltage GND. A voltage of a node between the first reception transistor RTR1 and the second reception transistor RTR2 may correspond to a level between the second power supply voltage VCCQ and the ground voltage GND. That is, the second electronic device 120 may generate the middle level. The internal circuit IC of the second electronic device 120 may receive the middle level.

Because the pull-up circuit DQPU and the pull-down circuit DQPD are turned off, the input impedance of the first electronic device 110 seen from the second electronic device 120 may be high impedance. Accordingly, due to the high impedance of the first electronic device 110, the middle level generated in the second electronic device 120 may be reflected from the first electronic device 110, that is, a reflected wave may be generated. The reflected wave may act as a noise at the middle level generated in the second electronic device 120.

The first electronic device 110 may turn off the pull-up circuit DQPU and the pull-down circuit DQPD and may activate the transmission matching circuit TMC. The transmission matching resistor RTMC and the transmission matching capacitor CTMC of the transmission matching circuit TMC may provide the impedance matching to the second electronic device 120. There may be no reflection from the first electronic device 110 due to the impedance matching. That is, the reflected wave of the middle level generated by the second electronic device 120 may be suppressed, and the noise of the middle level may be suppressed. Accordingly, the reliability of the first electronic device 110, the second electronic device 120, and the electronic system 100 is improved.

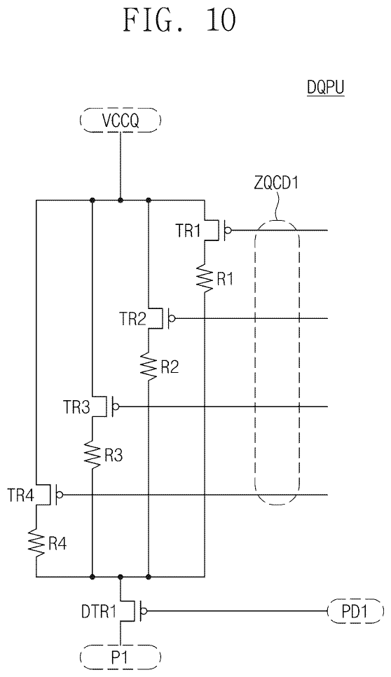

FIG. 10 illustrates an example of a pull-up circuit DQPU according to some implementations. In FIGS. 1, 2, and 10, the pull-up circuit DQPU may include a first transistor TR1, a second transistor TR2, a third transistor TR3, a fourth transistor TR4, a first resistor R1, a second resistor R2, a third resistor R3, a fourth resistor R4, and a first driving transistor DTR1.

The first transistor TR1 and the first resistor R1 may form a pair and may be connected between the power node to which the second power supply voltage VCCQ is applied and the first driving transistor DTR1. The second transistor TR2 and the second resistor R2 may form a pair and may be connected between the power node to which the second power supply voltage VCCQ is applied and the first driving transistor DTR1, to be parallel to the pair of first transistor TR1 and first resistor R1.

The third transistor TR3 and the third resistor R3 may form a pair and may be connected between the power node to which the second power supply voltage VCCQ is applied and the first driving transistor DTR1, to be parallel to the pair of first transistor TR1 and first resistor R1 and the pair of second transistor TR2 and second resistor R2.

The fourth transistor TR4 and the fourth resistor R4 may form a pair and may be connected between the power node to which the second power supply voltage VCCQ is applied and the first driving transistor DTR1, to be parallel to the pair of first transistor TR1 and first resistor R1, the pair of second transistor TR2 and second resistor R2, and the pair of third transistor TR3 and third resistor R3.

The first driving transistor DTR1 may include a gate controlled by the first pre-driver PD1, a first terminal connected to the power node to which the second power supply voltage VCCQ is applied, and a second terminal connected to the pair of first transistor TR1 and first resistor R1, the pair of second transistor TR2 and second resistor R2, the pair of third transistor TR3 and third resistor R3, and the pair of fourth transistor TR4 and fourth resistor R4.

The first transistor TR1, the second transistor TR2, the third transistor TR3, and the fourth transistor TR4 may be turned on or turned off by the first ZQ calibration code ZQCD1. The first driving transistor DTR1 may be turned on or turned off by the first pre-driver PD1.

When the first driving transistor DTR1 is turned on by the first pre-driver PD1, the pull-up circuit DQPU may be turned on and may pull up the first pad P1. A total resistance value between the power node and the first pad P1 may be determined by the first ZQ calibration code ZQCD1. A resistance value of a resistor connected to a transistor, which is turned on by the first ZQ calibration code ZQCD1, from among the first transistor TR1, the second transistor TR2, the third transistor TR3, and the fourth transistor TR4 may be applied to the total resistance value between the power node and the first pad P1. A resistance value of a resistor connected to a transistor, which is turned off by the first ZQ calibration code ZQCD1, from among the first transistor TR1, the second transistor TR2, the third transistor TR3, and the fourth transistor TR4 may not be applied to the total resistance value between the second power supply node VCCQ and the first pad P1.

The first ZQ calibration code ZQCD1 may be obtained as a result of the ZQ calibration operation which the first electronic device 110 or the second electronic device 120 performs by using the external resistor REXT and the ZQ calibration controller ZQC. The ZQ calibration operation may be performed to detect the first ZQ calibration code ZQCD1 at which the total resistance value between the power node of the pull-up circuit DQPU and the first pad P1 corresponds to (e.g., is the same as or similar to) the resistance value of the external resistor REXT. For example, the ZQ calibration operation may be used to detect the first ZQ calibration code ZQCD1 at which a reflected wave is suppressed through impedance matching.

In some implementations, the pull-up circuit DQPU is illustrated as including four transistor and resistor pairs. However, the number of transistor and resistor pairs included in the pull-up circuit DQPU is not limited thereto.

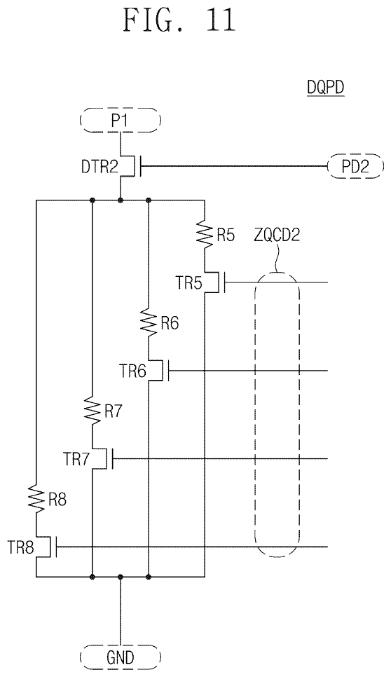

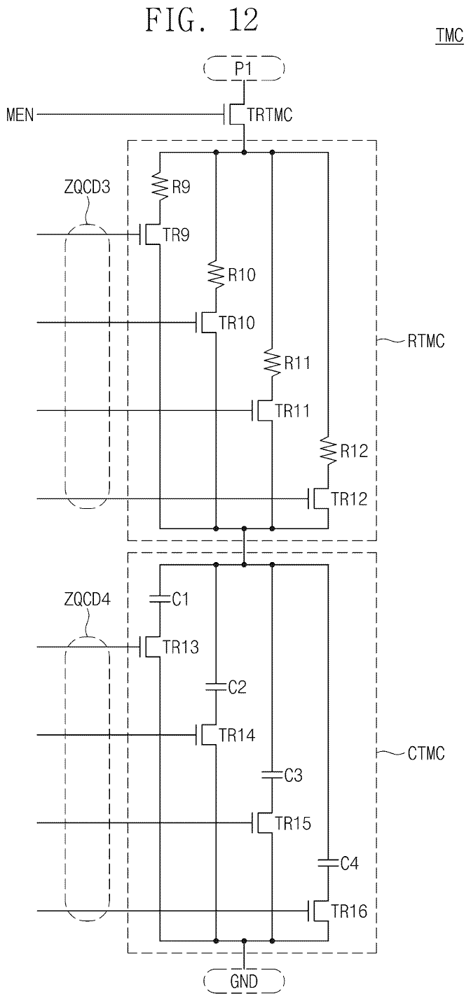

FIG. 11 illustrates an example of a pull-down circuit DQPD according to some implementations. In FIGS. 1, 2, and 11, the pull-down circuit DQPD may include a fifth transistor TR5, a sixth transistor TR6, a seventh transistor TR7, an eighth transistor TR8, a fifth resistor R5, a sixth resistor R6, a seventh resistor R7, an eighth resistor R8, and a second driving transistor DTR2.

The fifth transistor TR5 and the fifth resistor R5 may form a pair and may be connected between the second driving transistor DTR2 and the ground node to which the ground voltage GND is applied. The sixth transistor TR6 and the sixth resistor R6 may form a pair and may be connected between the second driving transistor DTR2 and the ground node to which the ground voltage GND is applied, to be parallel to the pair of fifth transistor TR5 and fifth resistor R5.

The seventh transistor TR7 and the seventh resistor R7 may form a pair and may be connected between the second driving transistor DTR2 and the ground node to which the ground voltage GND is applied, to be parallel to the pair of fifth transistor TR5 and fifth resistor R5 and the pair of sixth transistor TR6 and sixth resistor R6.

The eighth transistor TR8 and the eighth resistor R8 may form a pair and may be connected between the second driving transistor DTR2 and the ground node to which the ground voltage GND is applied, to be parallel to the pair of fifth transistor TR5 and fifth resistor R5, the pair of sixth transistor TR6 and sixth resistor R6, and the pair of seventh transistor TR7 and seventh resistor R7.

The second driving transistor DTR2 may include a gate controlled by the second pre-driver PD2, a first terminal connected to the pair of fifth transistor TR5 and fifth resistor R5, the pair of sixth transistor TR6 and sixth resistor R6, the pair of seventh transistor TR7 and seventh resistor R7, and the pair of eighth transistor TR8 and eighth resistor R8, and a second terminal connected to the first pad P1.

The fifth transistor TR5, the sixth transistor TR6, the seventh transistor TR7, and the eighth transistor TR8 may be turned on or turned off by the second ZQ calibration code ZQCD2. The second driving transistor DTR2 may be turned on or turned off by the second pre-driver PD2.

When the second driving transistor DTR2 is turned on by the second pre-driver PD2, the pull-down circuit DQPD may be turned on and may pull down the first pad P1. A total resistance value between the first pad P1 and the ground node may be determined by the second ZQ calibration code ZQCD2. A resistance value of a resistor connected to a transistor, which is turned on by the second ZQ calibration code ZQCD2, from among the fifth transistor TR5, the sixth transistor TR6, the seventh transistor TR7, and the eighth transistor TR8 may be applied to the total resistance value between the first pad P1 and the ground node. A resistance value of a resistor connected to a transistor, which is turned off by the second ZQ calibration code ZQCD2, from among the fifth transistor TR5, the sixth transistor TR6, the seventh transistor TR7, and the eighth transistor TR8 may not be applied to the total resistance value between the first pad P1 and the ground node.

The second ZQ calibration code ZQCD2 may be obtained as a result of the ZQ calibration operation which the first electronic device 110 or the second electronic device 120 performs by using the external resistor REXT and the ZQ calibration controller ZQC. The ZQ calibration operation may be performed to detect the second ZQ calibration code ZQCD2 at which the total resistance value between the first pad P1 and the ground node of the pull-down circuit DQPD corresponds to (e.g., is the same as or similar to) the resistance value of the external resistor REXT. For example, the ZQ calibration operation may be used to detect the second ZQ calibration code ZQCD2 at which a reflected wave is suppressed through impedance matching.

In some implementations, the pull-down circuit DQPD is illustrated as including four transistor and resistor pairs. However, the number of transistor and resistor pairs included in the pull-down circuit DQPD is not limited thereto.

FIG. 12 illustrates an example of a transmission matching circuit TMC according to some implementations. In FIGS. 1, 2, and 12, the transmission matching circuit TMC may include the transmission matching transistor TRTMC, the transmission matching resistor RTMC, and the transmission matching capacitor CTMC.

The transmission matching resistor RTMC may be implemented with a variable resistor. For example, the transmission matching resistor RTMC may include a ninth transistor TR9, a tenth transistor TR10, an eleventh transistor TR11, a twelfth transistor TR12, a ninth resistor R9, a tenth resistor R10, an eleventh resistor R11, and a twelfth resistor R12.

The ninth transistor TR9 and the ninth resistor R9 may form a pair and may be connected between the transmission matching transistor TRTMC and the transmission matching capacitor CTMC. The tenth transistor TR 10 and the tenth resistor R10 may form a pair and may be connected between the transmission matching transistor TRTMC and the transmission matching capacitor CTMC, to be parallel to the pair of ninth transistor TR9 and ninth resistor R9.

The eleventh transistor TR11 and the eleventh resistor R11 may form a pair and may be connected between the transmission matching transistor TRTMC and the transmission matching capacitor CTMC, to be parallel to the pair of ninth transistor TR9 and ninth resistor R9 and the pair of tenth transistor TR10 and tenth resistor R10.

The twelfth transistor TR12 and the twelfth resistor R12 may form a pair and may be connected between the transmission matching transistor TRTMC and the transmission matching capacitor CTMC, to be parallel to the pair of ninth transistor TR9 and ninth resistor R9, the pair of tenth transistor TR10 and tenth resistor R10, and the pair of eleventh transistor TR11 and eleventh resistor R11.

The transmission matching capacitor CTMC may be implemented with a variable capacitor. For example, the transmission matching capacitor CTMC may include a thirteenth transistor TR13, a fourteenth transistor TR14, a fifteenth transistor TR15, a sixteenth transistor TR16, a first capacitor C1, a second capacitor C2, a third capacitor C3, and a fourth capacitor C4.

The thirteenth transistor TR13 and the first capacitor C1 may form a pair and may be connected between the transmission matching resistor RTMC and the ground node to which the ground voltage GND is applied. The fourteenth transistor TR14 and the second capacitor C2 may form a pair and may be connected between the transmission matching resistor RTMC and the ground node to which the ground voltage GND is applied, to be parallel to the pair of thirteenth transistor TR13 and first capacitor C1.

The fifteenth transistor TR15 and the third capacitor C3 may form a pair and may be connected between the transmission matching resistor RTMC and the ground node to which the ground voltage GND is applied, to be parallel to the pair of thirteenth transistor TR13 and first capacitor C1 and the pair of fourteenth transistor TR14 and second capacitor C2.

The sixteenth transistor TR16 and the fourth capacitor C4 may form a pair and may be connected between the transmission matching resistor RTMC and the ground node to which the ground voltage GND is applied, to be parallel to the pair of thirteenth transistor TR13 and first capacitor C1, the pair of fourteenth transistor TR14 and second capacitor C2, and the pair of fifteenth transistor TR15 and third capacitor C3.

The transmission matching transistor TRTMC may include a gate controlled by the matching enable signal MEN, a first terminal connected to the pair of the ninth transistor TR9 and ninth resistor R9, the pair of tenth transistor TR10 and tenth resistor R10, the pair of eleventh transistor TR11 and eleventh resistor R11, and the pair of twelfth transistor TR12 and twelfth resistor R12, and a second terminal connected to the first pad P1.

The ninth transistor TR9, the tenth transistor TR10, the eleventh transistor TR11, and the twelfth transistor TR12 may be turned on or turned off by a third ZQ calibration code ZQCD3. The transmission matching transistor TRTMC may be turned on or turned off by the matching enable signal MEN.

When the transmission matching transistor TRTMC is turned on by the matching enable signal MEN, the transmission matching circuit TMC may be activated and may apply a total resistance value of the transmission matching resistor RTMC to the first pad P1. The total resistance value of the transmission matching resistor RTMC may be determined by the third ZQ calibration code ZQCD3. A resistance value of a resistor connected to a transistor, which is turned on by the third ZQ calibration code ZQCD3, from among the ninth transistor TR9, the tenth transistor TR10, the eleventh transistor TR11, and the twelfth transistor TR12 may be applied to the total resistance value of the transmission matching resistor RTMC. A resistance value of a resistor connected to a transistor, which is turned off by the third ZQ calibration code ZQCD3, from among the ninth transistor TR9, the tenth transistor TR10, the eleventh transistor TR11, and the twelfth transistor TR12 may not be applied to the total resistance value of the transmission matching resistor RTMC.

When the transmission matching transistor TRTMC is turned on by the matching enable signal MEN, the transmission matching circuit TMC may be activated and may apply a total capacitance of the transmission matching capacitor CTMC to the first pad P1. The total capacitance of the transmission matching capacitor CTMC may be determined by a fourth ZQ calibration code ZQCD4. A capacitance of a capacitor connected to a transistor, which is turned on by the fourth ZQ calibration code ZQCD4, from among the thirteenth transistor TR13, the fourteenth transistor TR14, the fifteenth transistor TR15, and the sixteenth transistor TR16 may be applied to the total capacitance of the transmission matching capacitor CTMC. A capacitance of a capacitor connected to a transistor, which is turned off by the fourth ZQ calibration code ZQCD4, from among the thirteenth transistor TR13, the fourteenth transistor TR14, the fifteenth transistor TR15, and the sixteenth transistor TR16 may not be applied to the total capacitance of the transmission matching capacitor CTMC.

In some implementations, the third ZQ calibration code ZQCD3 or the fourth ZQ calibration code ZQCD4 may be obtained as a result of the ZQ calibration operation which the first electronic device 110 or the second electronic device 120 performs by using the external resistor REXT and the ZQ calibration controller ZQC (e.g., as a result of a unique ZQ calibration operation for obtaining the third ZQ calibration code ZQCD3 or the fourth ZQ calibration code ZQCD4). Alternatively, the third ZQ calibration code ZQCD3 or the fourth ZQ calibration code ZQCD4 may be the same as one of the first ZQ calibration code ZQCD1 or the second ZQ calibration code ZQCD2.

As another example, the third ZQ calibration code ZQCD3 or the fourth ZQ calibration code ZQCD4 may be generated based on at least a portion of the first ZQ calibration code ZQCD1 and the second ZQ calibration code ZQCD2. For example, the third ZQ calibration code ZQCD3 or the fourth ZQ calibration code ZQCD4 may be obtained from a portion of the first ZQ calibration code ZQCD1 or the second ZQ calibration code ZQCD2.

As another example, the third ZQ calibration code ZQCD3 or the fourth ZQ calibration code ZQCD4 may be obtained by combining at least a portion of the first ZQ calibration code ZQCD1 and at least a portion of the second ZQ calibration code ZQCD2. Alternatively, the third ZQ calibration code ZQCD3 or the fourth ZQ calibration code ZQCD4 may be generated by performing an operation on at least a portion of the first ZQ calibration code ZQCD1 and at least a portion of the second ZQ calibration code ZQCD2.

As another example, the third ZQ calibration code ZQCD3 or the fourth ZQ calibration code ZQCD4 may be stored in the first electronic device 110 or the second electronic device 120 by a manufacturer in the process of manufacturing the first electronic device 110 or the second electronic device 120.

In some implementations, the transmission matching circuit TMC is illustrated as including four transistor and resistor pairs and four transistor and capacitor pairs. However, in the transmission matching circuit TMC, the number of transistor and resistor pairs and the number of transistor and capacitor pairs are not limited thereto.

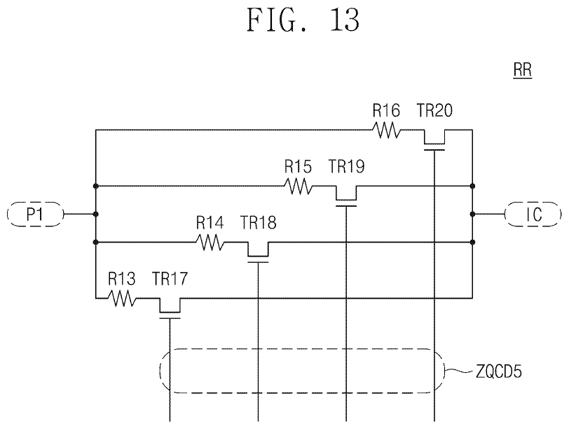

FIG. 13 illustrates an example of a reception resistor RR according to some implementations. In FIGS. 1, 2, and 13, the reception resistor RR may include a seventeenth transistor TR17, an eighteenth transistor TR18, a nineteenth transistor TR19, a twentieth transistor TR20, a thirteenth resistor R13, a fourteenth resistor R14, a fifteenth resistor R15, and a sixteenth resistor R16.

The seventeenth transistor TR17 and the thirteenth resistor R13 may form a pair and may be connected between the first pad P1 and the node of the internal circuit IC. The eighteenth transistor TR18 and the fourteenth resistor R14 may form a pair and may be connected between the first pad P1 and the node of the internal circuit IC, to be parallel to the pair of seventeenth transistor TR 17 and thirteenth resistor R13.

The nineteenth transistor TR 19 and the fifteenth resistor R15 may form a pair and may be connected between the first pad P1 and the node of the internal circuit IC, to be parallel to the pair of seventeenth transistor TR17 and thirteenth resistor R13 and the pair of eighteenth transistor TR18 and fourteenth resistor R14.

The twentieth transistor TR20 and the sixteenth resistor R16 may form a pair and may be connected between the first pad P1 and the node of the internal circuit IC, to be parallel to the pair of seventeenth transistor TR17 and thirteenth resistor R13, the pair of eighteenth transistor TR18 and fourteenth resistor R14, and the pair of nineteenth transistor TR19 and fifteenth resistor R15.

The seventeenth transistor TR17, the eighteenth transistor TR18, the nineteenth transistor TR19, and the twentieth transistor TR20 may be turned on or turned off by a fifth ZQ calibration code ZQCD5.

A total resistance value between the first pad P1 and the node of the internal circuit IC may be determined by the fifth ZQ calibration code ZQCD5. A resistance value of a resistor connected to a transistor, which is turned on by the fifth ZQ calibration code ZQCD5, from among the seventeenth transistor TR17, the eighteenth transistor TR18, the nineteenth transistor TR19, and the twentieth transistor TR20 may be applied to the total resistance value between the first pad P1 and the node of the internal circuit IC. A resistance value of a resistor connected to a transistor, which is turned off by the fifth ZQ calibration code ZQCD5, from among the seventeenth transistor TR17, the eighteenth transistor TR18, the nineteenth transistor TR 19, and the twentieth transistor TR20 may not be applied to the total resistance value between the first pad P1 and the node of the internal circuit IC.

In some implementations, the fifth ZQ calibration code ZQCD5 may be obtained as a result of the ZQ calibration operation which the first electronic device 110 or the second electronic device 120 performs by using the external resistor REXT and the ZQ calibration controller ZQC (e.g., as a result of a unique ZQ calibration operation for obtaining the fifth ZQ calibration code ZQCD5). Alternatively, the fifth ZQ calibration code ZQCD5 may be the same as one of the first ZQ calibration code ZQCD1 or the second ZQ calibration code ZQCD2.

As another example, the fifth ZQ calibration code ZQCD5 may be generated based on at least a portion of the first ZQ calibration code ZQCD1 and the second ZQ calibration code ZQCD2. For example, the fifth ZQ calibration code ZQCD5 may be obtained from a portion of the first ZQ calibration code ZQCD1 or the second ZQ calibration code ZQCD2.

As another example, the fifth ZQ calibration code ZQCD5 may be obtained by combining at least a portion of the first ZQ calibration code ZQCD1 and at least a portion of the second ZQ calibration code ZQCD2. Alternatively, the fifth ZQ calibration code ZQCD5 may be generated by performing an operation on at least a portion of the first ZQ calibration code ZQCD1 and at least a portion of the second ZQ calibration code ZQCD2.

As another example, the fifth ZQ calibration code ZQCD5 may be stored in the first electronic device 110 or the second electronic device 120 by a manufacturer in the process of manufacturing the first electronic device 110 or the second electronic device 120.

In some implementations, the reception resistor RR is illustrated as including four transistor and resistor pairs. However, the number of transistor and resistor pairs included in the reception resistor RR is not limited thereto.

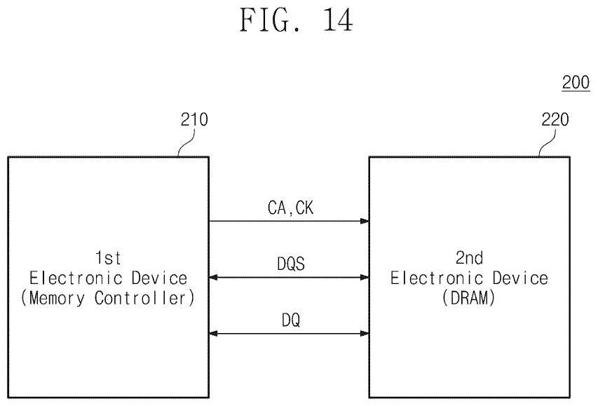

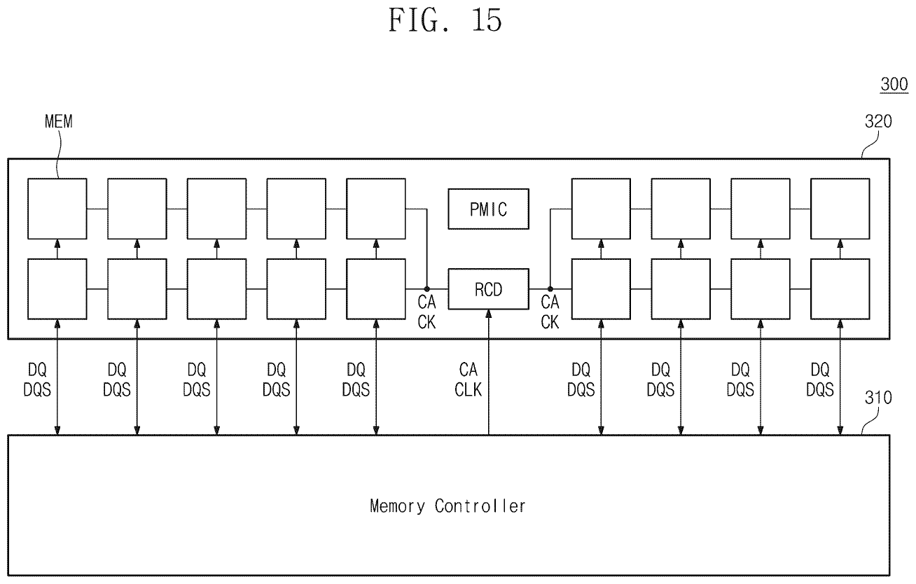

FIG. 14 illustrates an example of an electronic system 200 according to some implementations. In FIG. 14, the electronic system 200 may include a first electronic device 210 and a second electronic device 220. The first electronic device 210 and the second electronic device 220 may respectively correspond to the first electronic device 110 and the second electronic device 120 described with reference to FIGS. 1 to 13.

In some implementations, the first electronic device 210 may be a memory controller. The second electronic device 220 may be a memory device, for example, a dynamic random access memory (DRAM) device. The first electronic device 210 and the second electronic device 220 may communicate based on the double data rate (DDR) standard.

The first electronic device 210 may provide a command and address CA and a clock signal CK to the second electronic device 220. The first electronic device 210 and the second electronic device 220 may communicate a data strobe signal DQS. For example, the data strobe signal DQS may include a write data strobe signal which the first electronic device 210 generates so as to be transmitted to the second electronic device 220 and a read data strobe signal which the second electronic device 220 generates from the clock signal CK so as to be transmitted to the first electronic device 210.

The first electronic device 210 and the second electronic device 220 may communicate a data signal DQ in synchronization with the data strobe signal DQS. For example, the first electronic device 210 may transmit the data strobe signal DQS and the data signal DQ to the second electronic device 220. The second electronic device 220 may capture the data signal DQ in synchronization with the data strobe signal DQS. The second electronic device 220 may transmit the data strobe signal DQS and the data signal DQ to the first electronic device 210. The first electronic device 210 may capture the data signal DQ in synchronization with the data strobe signal DQS.

In some implementations, the first pads P1 described with reference to FIGS. 1 to 13 may be pads for transmitting the data signal DQ. The transceivers TR described with reference to FIGS. 1 to 13 may transmit and receive the data signal DQ based on the PAM3. When transmitting the data signal DQ of the high level, each of the transceivers TR may pull up the corresponding first pad P1. When transmitting the data signal DQ of the low level, each of the transceivers TR may pull down the corresponding first pad P1. When transmitting the data signal DQ of the middle level, each of the transceivers TR may activate the transmission matching circuit TMC without pulling up or pulling down the corresponding first pad P1.

FIG. 15 illustrates an example of a electronic system 300 according to some implementations. In FIG. 15, the electronic system 300 may include a first electronic device 310 and a second electronic device 320. The first electronic device 310 and the second electronic device 320 may respectively correspond to the first electronic device 110 and the second electronic device 120 described with reference to FIGS. 1 to 13.

In some implementations, the first electronic device 310 may be a memory controller. The second electronic device 320 may be a memory module. The first electronic device 310 and the second electronic device 320 may communicate with each other based on the dual in-line memory module (DIMM), a registered DIMM (RDIMM), or a load reduced DIMM (LRDIMM) standard.

The second electronic device 320 may include a register clock driver RCD, a power management integrated circuit (IC) PMIC, and memory devices MEM. The memory devices MEM may include, for example, DRAM devices.

The first electronic device 310 may provide the command and address CA and the clock signal CK to the register clock driver RCD of the second electronic device 320. The register clock driver RCD may provide the command and address CA and the clock signal CK in common to the memory devices MEM. The first electronic device 310 may supply a power to the power management IC PMIC of the second electronic device 320. The power management IC PMIC may supply the power to the register clock driver RCD and the memory devices MEM of the second electronic device 320.

The first electronic device 310 and the memory devices MEM of the second electronic device 320 may communicate the data strobe signal DQS. For example, the data strobe signal DQS may include a write data strobe signal which the first electronic device 310 generates so as to be transmitted to the memory devices MEM of the second electronic device 320 and a read data strobe signal which each of the memory devices MEM of the second electronic device 320 generates from the clock signal CK so as to be transmitted to the first electronic device 310.

The first electronic device 310 and the memory devices MEM of the second electronic device 320 may communicate the data signal DQ in synchronization with the data strobe signal DQS. For example, the first electronic device 310 may transmit the data strobe signal DQS and the data signal DQ to the memory devices MEM of the second electronic device 320. The memory devices MEM of the second electronic device 320 may capture the data signal DQ in synchronization with the data strobe signal DQS. The memory devices MEM of the second electronic device 320 may transmit the data strobe signal DQS and the data signal DQ to the first electronic device 310. The first electronic device 310 may capture the data signal DQ in synchronization with the data strobe signal DQS.

In some implementations, the first pads P1 described with reference to FIGS. 1 to 13 may be pads for transmitting the data signal DQ. The transceivers TR described with reference to FIGS. 1 to 13 may transmit and receive the data signal DQ based on the PAM3. When transmitting the data signal DQ of the high level, each of the transceivers TR may pull up the corresponding first pad P1. When transmitting the data signal DQ of the low level, each of the transceivers TR may pull down the corresponding first pad P1. When transmitting the data signal DQ of the middle level, each of the transceivers TR may activate the transmission matching circuit TMC without pulling up or pulling down the corresponding first pad P1.

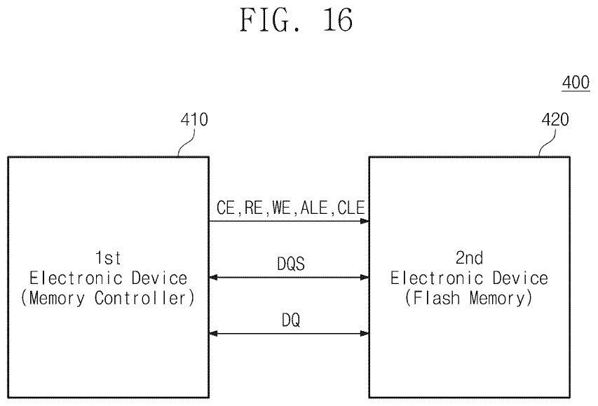

FIG. 16 illustrates an example of an electronic system 400 according to some implementations. In FIG. 16, the electronic system 400 may include a first electronic device 410 and a second electronic device 420. The first electronic device 410 and the second electronic device 420 may respectively correspond to the first electronic device 110 and the second electronic device 120 described with reference to FIGS. 1 to 13.

In some implementations, the first electronic device 410 may be a memory controller. The second electronic device 420 may be a memory device, for example, a flash memory device (e.g., a NAND flash memory device). The first electronic device 410 and the second electronic device 420 may communicate based on the toggle DDR standard. The first electronic device 410 may provide the second electronic device 420 with a chip enable signal CE, a read enable signal RE, a write enable signal WE, an address latch enable signal ALE, a command latch enable signal CLE.

The chip enable signal CE may activate the second electronic device 420. For example, when the second electronic device 420 includes a plurality of flash memory devices, the chip enable signal CE may activate at least one of the plurality of flash memory devices. The read enable signal RE may be used for the second electronic device 420 to generate the data strobe signal DQS. The address latch enable signal ALE may indicate that a signal transmitted through the data signal DQ is an address. The command latch enable signal CLE may indicate that a signal transmitted through the data signal DQ is a command.

The first electronic device 410 and the second electronic device 420 may communicate the data strobe signal DQS. For example, the first electronic device 410 may generate the data strobe signal DQS so as to be transmitted to the second electronic device 420, and the second electronic device 420 may generate the data strobe signal DQS from the read enable signal RE so as to be transmitted to the first electronic device 410. The waveform of the data strobe signal DQS which the second electronic device 420 transmits to the first electronic device 410 may be in a delayed shape of the waveform of the read enable signal RE. The read enable signal RE and the data strobe signal DQS may include an interval where a signal toggles and an interval where a signal does not toggle.

The first electronic device 410 and the second electronic device 420 may communicate the data signal DQ in synchronization with the data strobe signal DQS. For example, the first electronic device 410 may transmit the data strobe signal DQS and the data signal DQ to the second electronic device 420. The second electronic device 420 may capture the data signal DQ in synchronization with the data strobe signal DQS. The second electronic device 420 may transmit the data strobe signal DQS and the data signal DQ to the first electronic device 410. The first electronic device 410 may capture the data signal DQ in synchronization with the data strobe signal DQS.

In some implementations, the first pads P1 described with reference to FIGS. 1 to 13 may be pads for transmitting the data signal DQ. The transceivers TR described with reference to FIGS. 1 to 13 may transmit and receive the data signal DQ based on the PAM3. When transmitting the data signal DQ of the high level, each of the transceivers TR may pull up the corresponding first pad P1. When transmitting the data signal DQ of the low level, each of the transceivers TR may pull down the corresponding first pad P1. When transmitting the data signal DQ of the middle level, each of the transceivers TR may activate the transmission matching circuit TMC without pulling up or pulling down the corresponding first pad P1.

In the present disclosure, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

In the present disclosure, components according to some implementations of the present disclosure are referenced by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit, or circuits enrolled as an intellectual property (IP).

According to the present disclosure, an electronic device may drive a transmitter to transmit a signal and may transmit an additional signal by activating a matching circuit without turning on the transmitter. Accordingly, an electronic device capable of reducing power consumption caused during communication, an operating method of the electronic device, and an electronic system including electronic devices are provided.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. An electronic device comprising:
a pad configured to be connected to an external device; and
a transmitter configured to drive the pad in a first state, a second state, or a third state based on a signal being transmitted to the external device,
wherein the first state includes a pull-up state, the second state includes a pull-down state, and the third state includes a state in which the pad is connected to a ground node to which a ground voltage is applied through a matching circuit.

2. The electronic device of claim 1, wherein the transmitter is configured to deactivate the matching circuit based on the pad being driven to one of the first state and the second state.

3. The electronic device of claim 1, wherein the matching circuit includes:
a transistor connected to the pad and controlled by the internal circuit; and
a resistor and a capacitor that are connected in series between the transistor and the ground node.

4. The electronic device of claim 3, wherein the resistor includes a variable resistance element with a resistance value controlled by the internal circuit.

5. The electronic device of claim 4, wherein the resistance value is controlled based on at least a portion of a ZQ calibration code.

6. The electronic device of claim 4, wherein the electronic device is configured to perform ZQ calibration for controlling the resistance value.

7. The electronic device of claim 3, wherein the capacitor includes a variable capacitor with a capacitance controlled by the internal circuit.

8. The electronic device of claim 1, further comprising a receiver connected to the pad,
wherein the receiver includes a transimpedance amplify receiver.

9. The electronic device of claim 8, wherein the receiver includes:
a first transistor including a gate connected to the pad, a first terminal connected to a power node to which a power supply voltage is applied, and a second terminal connected to an internal node;
a second transistor including a gate connected to the pad, a first terminal connected to the ground node, and a second terminal connected to the internal node; and
a resistor connected between the pad and the internal node.

10. The electronic device of claim 9, wherein the resistor includes a variable resistance element with a resistance value controlled by an internal circuit.

11. The electronic device of claim 10, wherein the resistance value is controlled based on at least a portion of a ZQ calibration code.

12. The electronic device of claim 10, wherein the electronic device is configured to perform ZQ calibration for controlling the resistance value.

13. The electronic device of claim 8, wherein the transmitter is configured to deactivate the matching circuit based on a signal being received from the external device through the receiver.

14. The electronic device of claim 1,
wherein the electronic device is a memory device configured to receive a command and address signal and a clock signal from the external device, to communicate a data strobe signal with the external device, and to communicate a data signal with the external device in synchronization with the data strobe signal, and
wherein the transmitter is configured to transmit the data signal to the external device based on one of the first state, the second state, or the third state used to drive the pad.

15. The electronic device of claim 1,
wherein the electronic device is a memory device configured to receive a chip enable signal, a read enable signal, a write enable signal, and an address enable signal from the external device, to communicate a data strobe signal with the external device, and to communicate a data signal with the external device in synchronization with the data strobe signal, and
wherein the transmitter is configured to transmit the data signal to the external device based on one of the first state, the second state, or the third state.

16. A method of operating an electronic device that includes a transmitter and a receiver configured to communicate with an external device, the method comprising:
when transmitting a first signal to the external device using the transmitter, turning on a pull-up circuit of the transmitter, turning off a pull-down circuit of the transmitter, and deactivating a matching circuit of the transmitter;
when transmitting a second signal to the external device using the transmitter, turning off the pull-up circuit, turning on the pull-down circuit, and deactivating the matching circuit; and
when transmitting a third signal to the external device using the transmitter, turning off the pull-up circuit, turning off the pull-down circuit, and activating the matching circuit.

17. The method of claim 16, further comprising deactivating the matching circuit based on a signal being received from the external device using the transmitter.

18. The method of claim 16, further comprising:
performing ZQ calibration; and
adjusting an impedance of the matching circuit based on a result of the ZQ calibration.

19. An electronic system comprising:
a first electronic device including a first transmitter and a first receiver; and
a second electronic device including a second transmitter and a second receiver,
wherein the second receiver is configured to, based on the first transmitted being pulled up, generate a first signal in response to the first transmitter being pulled up,
wherein the second receiver is configured to, based on the first transmitter being pulled down, generate a second signal in response to the first transmitter being pulled down, and
wherein the second receiver is configured to, based on the first transmitter activating a first matching circuit, generate a third signal.

20. The electronic system of claim 19, wherein the second transmitter is configured to. based on one of the first signal. the second signal, or the third signal being communicated to the second transmitter by the first transmitter, deactivate a second matching circuit.
